(19) United States
(12) Patent Application Publication
(10) Pub. No.: US 2006/0140048 A1
(43) Pub. Date: Jun. 29, 2006

(54) Process for preparing siloxane-filler compositions using an extruder mixer

(76) Inventors: Rudi Ulzheimer, Idstein (DE); Stefan Reuss, York (GB)

Correspondence Address: McKellar Stevens;Poseyville Professional Complex, 784 South Poseyville Road, Midland, MI, 48640, US

(21) Appl. No.: 10/432,749

(22) PCT Filed: Nov. 23, 2001
(86) PCT No.: PCT/GB01/05176

§ 371 Date: Jun. 25, 2004

(30) Foreign Application Priority Data
Nov. 28, 2000 (GB) 0028888.6

(51) Int. Cl. B29B 7/00; B01F 7/08

(52) U.S. Cl. 366/84

(57) ABSTRACT

Methods describing a process for the production of polysiloxane containing masses, containing surface treated filler material, by continuously feeding materials to a screw extruder (12) in which they are mixed and conveyed to an outlet (14) with removal of gaseous materials therefrom. The screw extruder (12) has at least two screws (22) located in communicating chambers distributed radially about a common axis (26) and extending with the axis of each screw parallel to the common axis (26). The materials being mixed in the extruder typically comprise (a) a polysiloxane, (b a reinforcing filler and (c) a hydrophobing agent. Each material is fed into the extruder (12) as the material itself or in admixture with any one or more of the others of (a), (b) and (c).

### FIELD OF INVENTION

This invention is concerned with improvements in or relating to mixing compositions and to silicone compositions produced by such mixing.

### BACKGROUND OF THE INVENTION

Silicone compositions that can be applied or shaped in fluid condition and then cured are well known. Among such compositions are those that are intended to have a low viscosity during storage and application and yet provide products of high mechanical strength. Such compositions may be used for a variety of purposes and are especially favoured for use in coating or moulding operations in which they become cured, with or without a separate heating operation. Typically such compositions contain reinforcing filler, the most commonly used one being silica, to enhance mechanical properties of the cured product. Whilst assisting in reinforcing the final product, silica also tends to associate progressively with the polysiloxanes present in the fluid composition with corresponding increase in viscosity of the composition. It has become a practice to render the silica hydrophobic by suitable treatment of its surface.

Surface treatment of silica can be done with the silica in dry powder form and before introduction to the silicone composition, but is commonly done in-situ in the composition. Surface treating materials, for example hexamethyldisilazane or divinyltetramethyldisilazane, are therefore usually incorporated with water into the composition of polysiloxane and silica. Commonly, this mixing is done batchwise, but this is a slow process and the product may suffer from significant variations in quality between batches.

Continuous processes for in-situ treatment of silica have been proposed which employ twin screw extruders. The twin screw extruders may be extended in length to achieve mixing of materials but those employed are generally limited to a maximum length of 60 times the diameter of the screw, for engineering reasons. The proposed processes can be inefficient or uneconomical due to lack of residence time of the mixture in the extruder and low throughput of mixture through the extruder. Also, low density fillers contain a high proportion of air which leads to problems when continuously incorporating them into silicone polymers in a twin screw extruder. The rate of incorporation of filler into a composition has been one of the main throughput limitations in a continuous process.

### DETAILED DESCRIPTION OF THE INVENTION

We have now found that mixtures of polysiloxane and reinforcing filler can be prepared with improved efficiency by feeding selected materials to a screw extruder comprising more than two screws located in communicating chambers distributed radially about a common axis and extending with the axis of each screw parallel to the common axis.

The present invention provides in accordance with one of its aspects a process for production of polysiloxane containing masses containing surface treated filler material which comprises continuously feeding materials to a screw extruder in which they are mixed and conveyed to an outlet with removal of gaseous materials therefrom, the screw extruder comprising more than two screws located in communicating chambers distributed radially about a common axis and extending with the axis of each screw parallel to the common axis and the materials being mixed in the extruder comprising;
a) a polysiloxane having more than 40 siloxane units selected from the group consisting of trialklysilyl end blocked polysiloxanes or polysiloxanes having at least one silicon bonded alkenyl, hydroxyl or hydrolysable group,
b) a reinforcing filler material selected from the group consisting of finely divided silica, surface treated finely divided silica, calcium carbonate, surface treated finely divided calcium carbonate, quartz powder, aluminium hydroxide, zirconium silicate, diatomaceous earth and titanium dioxide;
c) an hydrophobing agent selected from the group consisting of disilazanes with water and polydiorganosiloxanes of up to 40 siloxane units having silicon bonded hydroxyl or amino groups,
each of the materials having been fed into the extruder as the material itself or in admixture with any one or more of the others of (a), (b), and (c).

In a process according to the invention, we prefer to employ an extruder in which three or more screws are spaced around equal angular sectors such for example as more fully described in U.S. Pat. No. 5,836,682.

Preferably the screws are confined in a housing having inner and outer casing elements that together define the chambers in which the screws rotate. Preferably the inner and outer casing elements are secured together and disposed with the common axis at least substantially horizontal. Preferably each screw has a plurality of processing elements that closely interengage on adjacent shafts. Preferably the extruder has ten or more, for example twelve, interengaging screws arranged with their axes disposed radially equidistant from the common axis so as to co-operate in mixing and conveying materials through the extruder to its outlet. In a preferred extruder, the twelve screws intermesh closely and are arranged in a circle around a core. Material within the extruder is mixed whilst being caused to move axially of the extruder and in the ring provided by the chambers, as in a spiral. Preferably the length of each extruder screw is from 25 to 60 times the diameter of the screw. Preferably the diameter of each extruder screw is from 20 to 160 mm. In a preferred process according to the invention, the screws are rotated in the same sense and at a speed from 50 to 1200 rpm.

In a process according to the present invention, we prefer to arrange that the interior of the extruder provides at least first, second and third mixing zones spaced along the common axis. Preferably, in a first of the zones a first portion of each screw meshes with a first portion of each of those screws adjacent to it so that the regime in this first zone is predominantly feeding of mixture towards subsequent zones. Preferably in a second of the zones, portions of the screws are arranged to promote intensive kneading and dispersing of the mixture as well as feeding it to subsequent zones. Preferably, in a third zone, portions of the screws are arranged to promote kneading and dispersing of the mixture as well as feeding it towards the outlet. Preferably, there is also a fourth zone in which portions of the screws are arranged to promote further kneading and dispersing of the mixture as well as feeding it,

In a preferred process the first zone has a length of 5 to 30 times the diameter of a screw. Preferably the temperature of material in the first zone is controlled at less than 100° C. Preferably the second zone has a length of 5 to 30 times the diameter of a screw. Preferably the temperature of material in the second zone is controlled at less than 150° C. Preferably, the third zone has a length of 5 to 15 times the length of a screw. Preferably the temperature of material in the third zone is controlled at 100° C. to 350° C. Preferably, material in the third zone is subject to reduced pressure. When present, the fourth zone preferably has a length of 5 to 15 times the diameter of a screw. Preferably the temperature of material in the fourth zone when present is controlled at less than 250° C.

The polysiloxanes (a) used in a process according to the invention may be linear or branched and have a viscosity from a fluid to a gum. These materials comprise siloxane chain units XₚR_{q}SiO_{(4-(p+q))/2} and chain terminating units preferably of the general formula XR₂SiO_{1/2}, in which each R represents a monovalent hydrocarbon group containing up to 12 carbon atoms, for example methyl or phenyl which may be substituted or not, X represents a group R or an alkenyl, hydroxyl or hydrolysable group, p has a value of 0, 1 or 2, q has a value of 0, 1 or 2 and the sum of p+q has a value of 0, 1 or 2. Preferred polysiloxanes (a) are at least substantially linear materials consisting predominantly of chain units of the general formula R₂SiO where R represents the methyl group. Suitable materials include trimethylsilyl terminated polydimethylsiloxanes having a viscosity of 350 mPas or more, methylvinylpolysiloxanes of viscosities from about 2000 to 60000 mPas, α,ω-dihydroxypolydiorganosiloxanes having viscosities from about 5000 to 11000 mPas and fluorinated polydiorganosiloxanes.

In a process according to the invention, the reinforcing filler (b) may be any of those normally employed in silicone compositions, for example high surface area silicas or calcium carbonates, quartz powder, aluminium hydroxide, zirconium silicate, diatomaceous earth and titanium dioxide. If desired, the reinforcing filler fed to the extruder may consist in whole or in part of surface treated silica or calcium carbonate for example silica which has been rendered hydrophobic by treatment of its surface with silane or silazane.

When a reinforcing filler is used which has not been surface treated to render it hydrophobic, it is preferred to additionally feed an hydrophobing agent (c) to the extruder. Preferably, the hydrophobing agent is selected from the group consisting of disilazanes with water and polydiorganosiloxanes of up to 40 siloxane units having silicon bonded hydroxyl or amino groups. Suitable disilazanes include hexamethyldisilazane and tetramethyldivinyldisilazane. The polydiorganosiloxanes referred to are preferably linear polydiorganosiloxanes having chain units as referred to above.

In a process according to the invention we prefer that one of the materials fed to the extruder is a mixture (d) which is a product formed by mixing polysiloxane (a) and filler (b) (which is preferably fumed or precipitated silica) and optionally other materials. Conveniently such a mixture (d) may be mixed in a separate continuous mixing apparatus for example one which operates by way of a rotor stator mixer with forced axial transport or a twin screw mixer with a very high outer diameter to inner diameter ratio in order to allow a high free volume and is therefore able to mix larger amounts of light fillers, such a twin screw will typically be co-rotating, with overlapping screw agitators which rotate at a consistent speed as the ingredients are fed at various points along its length. Depending on the formulation and the output of this mixer, it may feed directly to the extruder or alternatively the mixing apparatus may feed to a reservoir in which the mixture is stored and aged before delivery to the extruder.

In a process according to the invention, the mixture (d) is preferably a powder or a paste which has been formed by mixing materials (a), (b) and (c) in proportions by weight such that for 100 parts silica there are employed 50 to 180 parts polysiloxane (a). When the material is a paste it preferably contains about 110 to 280, parts by weight of polysiloxane (a) per 100 parts by weight of the filler, and when the mixture (d) is a powder, it preferably contains about 70 to 110 parts by weight of polysiloxane (a) per 100 parts by weight filler. Preferably (c) is present in about 10 to 30, most preferably 15 to 25 parts by weight and d is present in the range of 2 to 10 parts by weight most preferably 3 to 6 by weight per 100 parts by weight filler.

In a process according to the invention, the materials are preferably fed to the screw extruder in proportions to provide in the first second and third zones a ratio of 70 to 180 parts by weight of polysiloxane (a) to 100 parts by weight of filler (b).

A process according to the invention is useful for processing filler/polysiloxane polymer masses generally and is especially suitable for preparation of masterbatches intended for further processing to provide formulations in one or more parts for curing to provide a finished product.

The invention provides in another of its aspects a process for production of a masterbatch for processing into a curable product which comprises continuously feeding materials to a screw extruder in which they are mixed and conveyed to an outlet with removal of gaseous materials therefrom characterised in that the screw extruder comprises more than two screws located in communicating chambers distributed radially about a common axis and extending with the axis of each screw parallel to the common axis and in that the materials fed to the screw extruder consist essentially of
a) a polysiloxane having more than 40 siloxane units selected from the group consisting of trialklysilyl end blocked polysiloxanes and polysiloxanes having at least one silicon bonded alkenyl, hydroxyl or hydrolysable group,
b) a reinforcing filler material selected from the group consisting of finely divided silica, calcium carbonate, quartz powder, aluminium hydroxide, zirconium silicate, diatomaceous earth and titanium dioxide,
c) an hydrophobing agent selected from the group consisting of disilazanes and polydiorganosiloxanes of up to 40 siloxane units having silicon bonded hydroxyl or amino groups and
d) water and/or
e) the product formed by mixing any two or more of a), b), c) and d).

In accordance with another aspect of the invention, the materials from the outlet of the extruder may be further compounded with other materials, including for example curatives, catalysts, inhibitors plasticisers, extenders and non-reinforcing fillers.

Curatives that may be incorporated include for example polysiloxanes incorporating silicon-bonded hydrogen atoms for reaction with alkenylpolysiloxanes of the masterbatch, and hydrolysable silanes and siloxanes for reaction with polysiloxanes of the masterbatch having hydroxyl or hydrolysable groups. Catalysts that may be incorporated include, for example, platinum catalysts for the hydrosilylation reaction, organometal salts or complexes for promoting condensation cure, and peroxides. Inhibitors may be incorporated to vary the rate of reaction in the cured product.

Plasticisers and extenders that may be incorporated include for example trimethylsilyl-terminated polydimethylsiloxane.

Non reinforcing fillers which may be incorporated may be selected from, for example iron oxide, zinc oxide, carbon black, glass microballoons, and carbonates of calcium, magnesium, barium or zinc and barium sulphate.

Processes according to the invention contribute to improved efficiency of production facilities and yield products of good consistency comparatively quickly.

In order that the invention may become clearer there now follows a description to be read with the accompanying drawings of a process selected for description to illustrate the invention by way of example. In the examples, all parts are by weight and all viscosities were measured at 25° C. and it should be understood that Premixes A, B, C and D discussed in the following examples are alternative mixtures referred to above as mixture (e).

### BRIEF DESCRIPTION OF THE DRAWINGS

FIG. 1 is a plan of a multiple screw extruder used in the illustrative process,

FIG. 2 is a side elevation of a portion of the extruder shown in FIG. 1,

FIG. 3 is sectional view taken substantially on the line A-A of FIG. 2,

FIG. 4 is a diagram of a screw located in the extruder.

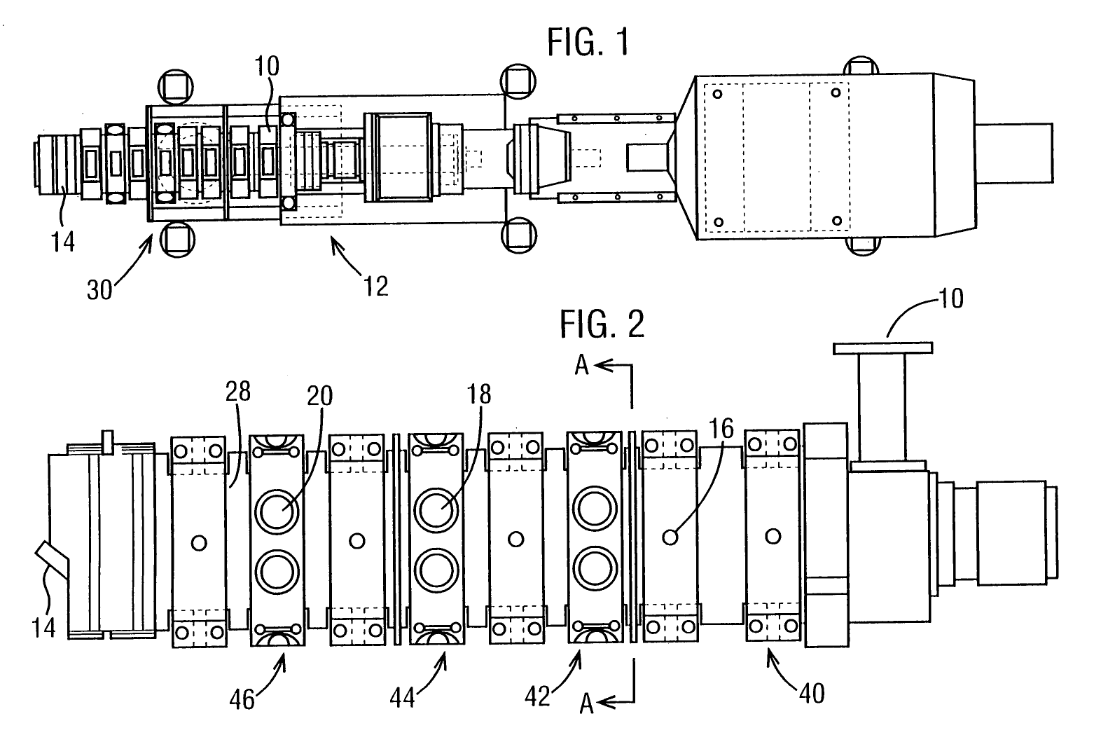

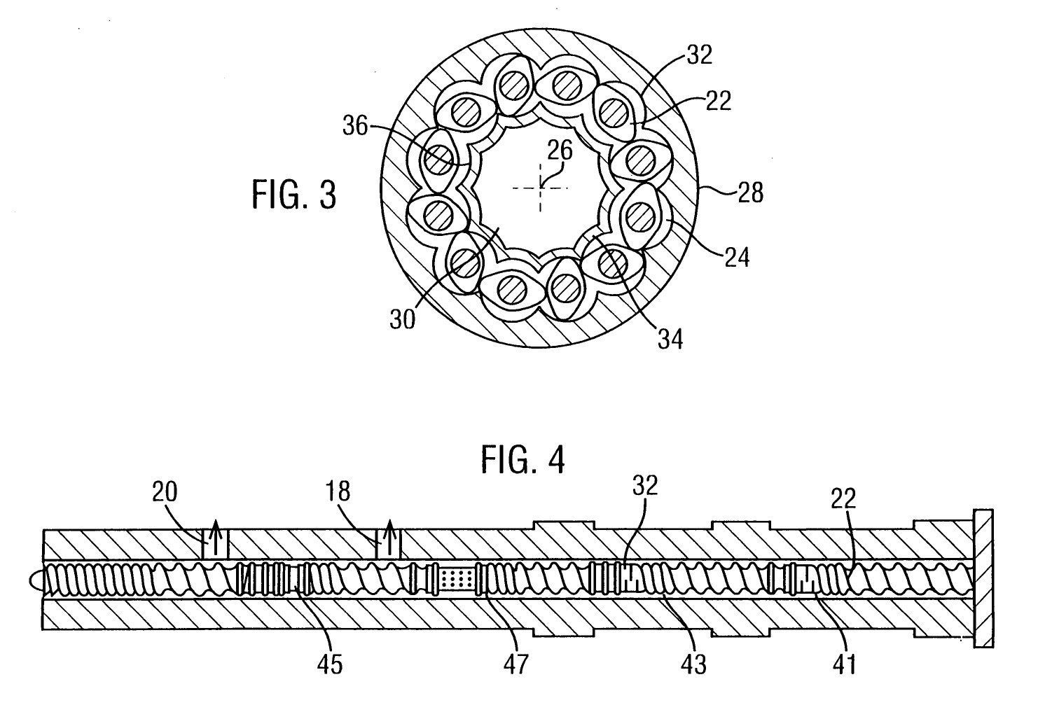

The illustrative process is for production of polysiloxane containing masses incorporating surface treated filler material, which comprises continuously feeding materials to an inlet (10) of a screw extruder (12) in which they are mixed and conveyed to an outlet (14) with removal of gaseous materials therefrom via vents (16, 18, 20). The vent (16) may be arranged to vent air from the extruder as mixing is carried out or to feed material into the extruder for mixing with other ingredients. Means are provided for heating and/or cooling various sectors of the extruder as required during operation of the extruder. The screw extruder (12) comprises twelve screws (22) located in communicating chambers (24) distributed radially about a common axis (26) and extending with the axis of each screw parallel to the common axis (26). The extruder comprises a housing having a generally cylindrical outer casing (28) disposed with its axis substantially horizontal and providing the common axis (26). A cavity (30) extends through it about the substantially horizontal common axis (26). The interior of the outer casing (28) is profiled to define a plurality of part cylindrical surfaces (32) equidistant from the common axis and spaced around equal angular sectors around the perimeter of the cavity (30). An inner casing portion (34) of the housing is secured to the outer casing within the cavity (30). Its outer surface is profiled to define part cylindrical surfaces (36) complementary to the surfaces (32) of the outer casing (28). The surfaces (32) and (36) together define the chambers (24) which communicate with adjacent chambers and each receive a screw (22) arranged for rotation about an axis parallel to that of the housing. The diameter of each extruder screw is 30 mm. The length of each extruder screw was 32 times the diameter of the screw. In processes according to the invention, the screws are rotated in the same sense and at a speed from 50 to 1200 rpm.

Each screw 22 has portions profiled to promote desired kneading or feeding of mixture within the extruder. These portions of the screws are positioned on the screws and within the extruder so as to provide a first (40), second (42), third (44) and fourth (46) mixing zones disposed axially in the extruder. In the first zone (40) a first portion (41) of each screw meshes with a first portion (41) of each of those screws adjacent to it so that the regime in this first zone is predominantly feeding of mixture towards subsequent zones. In the second zone (42), portions (43) of the screws are arranged to promote intensive kneading and dispersing of the mixture as well as feeding it to subsequent zones. In the third zone (44), portions (45) of the screws are arranged to promote kneading and dispersing of the mixture as well as feeding it towards the outlet. In the fourth zone (46) portions (47) of the screws are arranged to promote further kneading and dispersing of the mixture as well as feeding it,

In a preferred process the first zone has a length of 5 to 30 times the diameter of a screw and the temperature of material in the first zone is controlled at less than 100° C. The second zone has a length of 5 to 15 times the diameter of a screw and the temperature of material in the second zone is controlled at less than 150° C. The third zone has a length of 5 to 30 times the length of a screw and the temperature of material in the third zone is controlled at 100° C. to 350° C. The fourth zone has a length of 5 to 15 times the diameter of a screw and the temperature of material in the fourth zone is controlled at less than 250° C.

Preferably, material in the third zone is subject to reduced pressure of between −100 and −1000 mbar (i.e. between −10⁴ and −10⁵ Pa), pulled via the vents (18, 20).

### EXAMPLE 1

100 parts of a vinyl functional polydiorganosiloxane having a viscosity of 55,000 mPas (a) were mixed with 100 parts of a fumed silica having surface area of 255 m²/g (b), 22.5 parts of hexamethyldisilazane (c) and 6 parts of water in a twin shaft extruder having an outer diameter: inner diameter ratio of 2.7 to form a powder (Premix A). Premix A was transferred into the feed section of the barrel of a twin screw extruder in which the screws were each of 30 mm diameter and of a length of 45 times their diameter and rotating at 500 rpm. 60 parts of the vinyl functional polydiorganosiloxane (a) were added in the feed section of the twin screw extruder and the mixture was compounded to a uniform paste (in an extruder feed and intensive mixing section of the extruder) having a temperature of less than 100° C. In a third extruder section, the paste was heated to 275° C. and exposed to reduced pressure of −900 mbar (−9×10⁴ Pa) to remove hexamethyldisilazane and water as well as by-products. In a fourth section, a further 71 parts of the polydiorganosiloxane (a) were added to form a homogeneous paste suitable for formulation to provide a curable composition.

The obtained paste was dispensed from the extruder and cooled. The maximum output of the extruder was 6.6 kg/h. Its viscosity was measured 24 hours after dispensing using a cone and plate viscometer at 10 s⁻¹ shear rate and found to be 1490 mPas.

### EXAMPLE 2

94 parts of the vinyl functional polydiorganosiloxane having a viscosity of 55,000 mPas (a) used in Example 1 were mixed with 100 parts of the silica (b) used in Example 1, 21.4 parts of hexamethyldisilazane (c) and 6.6 parts of water in a rotor stator mixer with forced axial transport to form a powder (Premix B). Premix B was transferred into the inlet (10) of the twelve screw extruder in which the screws were rotating at 230 rpm. 64 parts of the vinyl functional polydiorganosiloxane (a) were added in the feed section of the screw extruder and the mixture was compounded to a uniform paste (in the extruder feed and intensive mixing section of the extruder) having a temperature of less than 100° C. In the third extruder section, the paste was heated to 210° C. and exposed to reduced pressure of −900 mbar (−9×10⁴ Pa) to remove hexamethyldisilazane and water as well as by-products. In the fourth section, a further 73 parts of the polydiorganosiloxane (a) were added and mixing continued to form a homogeneous paste suitable for formulation to provide a curable composition.

The obtained paste was dispensed from the extruder and cooled. The maximum output of the extruder was 103 kg/hr. Its viscosity was measured, 24 hours after dispensing using a cone and plate viscometer at 10 s⁻¹ shear rate and found to be 860 mPas.

As can be seen from the data, the process used in Example 2 provided a composition of lower viscosity than that of Example 1 with the same overall formulation, indicating better treatment of the silica and better stripping of volatiles. Additionally the throughput achieved in Example 2 is more than 15 times higher compared to Example 1, making the process of Example 2 economically much more attractive than that of Example 1.

### EXAMPLE 3

91 parts of the vinyl functional polydiorganosiloxane having a viscosity of 55,000 mPas (a) used in Example 1 were mixed with 100 parts of the silica (b) used in Example 1, 20 parts of hexamethyldisilazane (c) and 6 parts of water in a continuous rotor stator mixer with forced axial transport to form a powder (Premix C). Premix C was transferred into the inlet (10) of the twelve screw extruder in which the screws were rotating at 230 rpm. 61 parts of the vinyl functional polydiorganosiloxane (a) were added in the feed section of the screw extruder and the mixture was compounded to a uniform paste (in the extruder feed and intensive mixing section of the extruder) having a temperature of less than 100° C. In the third extruder section, the paste was heated to 210° C. and exposed to reduced pressure of −900 mbar (−9×10⁴ Pa) to remove hexamethyldisilazane and water as well as by-products. In the fourth section, a further 79 parts of the polydiorganosiloxane (a) were added and mixing continued to form a homogeneous paste suitable for formulation to provide a curable composition.

The obtained paste was dispensed from the extruder and cooled. The maximum output of the extruder was 110 kg/hr. Its viscosity was measured, 24 hours after dispensing using a cone and plate viscometer at 10 s⁻¹ shear rate and found to be 822 mPas. A 2 mm thick layer of the obtained paste coated onto a plastic foil was observed to have a smooth appearance with no visible particles.

### EXAMPLE 4

91 parts of the vinyl functional polydiorganosiloxane having a viscosity of 55,000 mPas (a) used in Example 1 were mixed with 100 parts of the silica (b) used in Example 1, 20 parts of hexamethyldisilazane (c) and 6 parts of water in a rotor stator mixer with forced axial transport to form a powder (Premix D). Premix D was transferred into the inlet (10) of the twelve screw extruder in which the screws were rotating at 230 rpm. 175 parts of the vinyl functional polydiorganosiloxane (a) were added in the feed section of the screw extruder and the mixture was compounded to a uniform paste (in the extruder feed and intensive mixing section of the extruder) having a temperature of less than 100° C. In the second and third extruder sections, the paste was heated to 210° C. and exposed to reduced pressure of −900 mbar (−9×10⁴ Pa) to remove hexamethyldisilazane and water as well as by-products.

The obtained paste was dispensed from the extruder and cooled. The maximum output of the extruder was 150 kg/hr. Its viscosity was measured, 24 hours after dispensing using a cone and plate viscometer at 10 s⁻¹ shear rate and found to be 1729 mPas. A 2 mm thick layer of the obtained paste coated onto a plastic foil was observed to have a grainy appearance with many silica particles visible.

The results show that the paste obtained in Example 4 had a higher viscosity than the one produced in Example 3, despite having a higher content of polysiloxane. Additionally, the appearance of the paste obtained in Example 4 had a poorer appearance due to inadequately dispersed filler particles.

1. A process for production of polysiloxane containing masses that contain surface treated filler material the process comprising
(I) continuously feeding materials to a screw extruder in which they are mixed and
(II) thereafter conveying the masses to an outlet while removing gaseous materials therefrom, wherein the screw extruder comprises more than two screws located in communicating chambers that are distributed radially about a common axis and that extend with the axis of each screw parallel to the common axis, said materials being mixed in the extruder comprising;
a) a polysiloxane having more than 40 siloxane units selected from the group consisting of
(i) trialkylsilyl end blocked polysiloxanes and
(ii) polysiloxanes having at least one silicon bonded group selected from the group consisting of alkenyl groups, hydroxyl groups and hydrolysable groups;
b) a reinforcing filler material selected from the group consisting of finely divided silica, surface treated finely divided silica, finely divided calcium carbonate, surface treated finely divided calcium carbonate, quartz powder, aluminium hydroxide, zirconium silicate, diatomaceous earth and titanium dioxide, and
c) a hydrophobing agent selected from the group consisting of disilazanes and water and polydiorganosiloxanes of up to 40 siloxane units having silicon bonded groups selected from the group consisting of hydroxyl groups and amino groups,
each of the materials having been fed into the extruder individually, or in admixture with any one or more of (a), (b) and (c).

2. A process according to claim 1 further characterized in that the finely divided filler is selected from the group consisting of fumed and precipitated silica.

3. A process according to claim 2 further characterized in that a mixture (d) comprising polysiloxane (a) and silica (b) in a ratio from 0.7 to 1.8 parts a) to 1 part silica, is fed to the extruder.

4. A process according to claim 3 further characterized in that mixture (d) is selected from the group consisting of a paste and a powder.

5. A process according to claim 3 further characterized in that the mixture (d) is stored in a reservoir after having been mixed and before introduction to the extruder.

6. A process according to claim 5 further characterized in that mixture (d) has been aged for a period of not less than ten minutes after mixing and before delivery to the extruder.

7. A process according to claim 3 further characterized in that mixture (d) is fed to the extruder from a separate continuous mixing unit where the component materials have a residence time between thirty seconds and five minutes.

8. A process according to claim 1 further
characterized in that the extruder has twelve screws arranged to co-operate in mixing and conveying materials through the extruder to its outlet.

9. A process according to claim 8 further characterized in that the length of each extruder screw is from 25 to 60 times the diameter of the screw.

10. A process according to claim 8 further characterized in that the diameter of each extruder screw is from 20 to 160 mm.

11. A process according to claim 8, further characterized in that the screws are rotated in the same sense and at a speed from 50 to 1200 rpm.

12. A process according to claim 1 further
characterized in that the interior of the extruder provides zones which in a first zone, a first portion of each screw meshes with a first portion of each of those screws adjacent to it so that the regime in this first zone is predominantly feeding of mixture towards a subsequent zone, and in a which there is a second zone in which portions of the screws are arranged to promote intensive kneading and dispersing of the mixture as well as feeding it to subsequent zones, and a third zone in which portions of the screws are arranged to promote kneading and dispersing of the mixture as well as feeding it towards the outlet.

13. A process according to claim 12 further characterized in that the first zone has a length of 5 to 30 times the diameter of a screw.

14. A process according to claim 12
further characterized in that the second zone has a length of 5 to 15 times the diameter of a screw.

15. A process according to claim 12,
further characterized in that the third zone has a length of 5 to 30 times the length of a screw.

16. A process according to claim 12 further characterized in that the material in the first three zones of the extruder comprises between 70 and 180 parts of (a) per 100 parts of (b).

17. A process according to claim 12
further characterized in that material in the third zone is subject to reduced pressure.

18. A process according to claim 12 further characterized in that it comprises a fourth zone in which portions of the screws are arranged to promote kneading and dispersing of the mixture as well as feeding it, this zone having a length of 5 to 15 times the diameter of a screw.

19. A process according to claim 2 further characterized in that the materials fed to the screw extruder comprise a polysiloxane (a) which is a polysiloxane having more than 40 siloxane units which has at least one silicon bonded alkenyl group and a product (e) formed by mixing finely divided silica, a polysiloxane having more than 40 siloxane units which has at least one silicon bonded alkenyl group, water and an hydrophobing agent comprising a disilazane or polydiorganosiloxanes of up to 40 siloxane units having silicon bonded hydroxyl groups.

20. A process for production of polysiloxane containing masses containing surface treated filler material that comprises (I) continuously feeding materials to a screw extruder in which the materials are mixed and thereafter (II) conveying the mixed materials to an outlet, with removal of gaseous materials therefrom, characterized, in that, the screw extruder comprises more than two screws located in communicating chambers distributed radially about a common axis and extending with the axis of each screw parallel to the common axis and, in that, the materials fed to the screw extruder consist essentially of
A. a polysiloxane having more than 40 siloxane units selected from the group consisting of trialkylsilyl end blocked polysiloxanes, polysiloxanes having at least one silicon bonded group selected from the group consisting of alkenyl groups, hydroxyl groups, and hydrolysable group;
B. a reinforcing filler material selected from the group consisting of finely divided silica, calcium carbonate, quartz powder, aluminium hydroxide, zirconium silicate, diatomaceous earth and titanium dioxide,
C. an hydrophobing agent selected from the group consisting of
(i) disilazanes and water
(ii) polydiorganosiloxanes of up to 40 siloxane units having silicon bonded groups selected from the groups consisting of
a. hydroxyl groups, and
b. amino groups and,
(iii) the product formed by mixing any of A, B, C(i), C(ii) and C(iii).

21. (canceled)

22. A process according to claim 20 further characterized in that, the materials delivered from the outlet of the extruder are further compounded with at least one material, selected from curatives, catalysts, inhibitors, plasticizers, extenders and non-reinforcing fillers, to provide a curable product.

23. A process according to claim 12 further characterized in that the first zone has a a temperature of the material controlled at less than 100° C.

24. A process according to claim 12 further characterized in that the first zone has a length of 5 to 30 times the diameter of a screw and the temperature of material in the first zone is controlled at less than 100° C.

25. A process according to claim 12 further characterized in that the temperature of the materials in the second zone is controlled at less than 150° C.

26. A process according to claim 12 further characterized in that the second zone has a length of 5 to 15 times the diameter of a screw and the temperature of material in the second zone is controlled at less than 150° C.

27. A process according to claim 12 further characterized in that the temperature of material in the third zone is controlled at 100° C. to 350° C.

28. A process according to claim 12 further characterized in that it comprises a fourth zone in which portions of the screws are arranged to promote kneading and dispersing of the mixture as well as feeding it, the temperature of material in the fourth zone being controlled at less than 250° C.

29. A process according to claim 12 further characterized in that it comprises a fourth zone in which portions of the screws are arranged to promote kneading and dispersing of the mixture as well as feeding it, the fourth zone having a length of 5 to 15 times the diameter of a screw and the temperature of the material in the fourth zone being controlled at less than 250° C.

30. A process according to claim 1 further characterized in that, the materials delivered from the outlet of the extruder are further compounded with other materials, including materials selected from the group consisting of curatives, catalysts, inhibitors, plasticizers, extenders and non-reinforcing fillers, to provide a curable product.
